(19) United States
(12) Patent Application Publication
(10) Pub. No.: US 2024/0333870 A1
(43) Pub. Date: Oct. 3, 2024

(54) AUGMENTING PLAYBACK OF A RECORDING THROUGH USER INTERACTION

(71) Applicant: International Business Machines Corporation, Armonk, NY (US)

(72) Inventor: ARTHUR DE MAGALHAES, MARKHAM (CA)

(21) Appl. No.: 18/126,518

(22) Filed: Mar. 27, 2023

(51) Int. Cl. H04N 5/92

(52) U.S. Cl. CPC H04N 5/9205

(57) ABSTRACT

Provided is a method, system, and computer program product for interacting with a recording. In response to a playback by a user of a recording comprising at least one of an audio portion or a video portion, a processor may record an interaction of the user including at least one of asking a question or answering a question, during the playback to create a recorded interaction. The processor may combine the recorded interaction with a recent context of the recording of a predetermined duration as a memory aid to the user to create an augmented recording. The processor may store the augmented recording in a repository as a single playback subset to form an artifact. The processor may send a link to the artifact to a target audience of users using a predetermined method of communication associated with each respective user.

### BACKGROUND

The present disclosure relates generally to audio and/or video recordings and, more specifically, to augmentation of an audio and/or video recording using a recording interaction platform.

With the advent of remote working opportunities, web-based meetings and/or virtual conferencing have become a ubiquitous occurrence for many workers. In most instances, these web-based meetings are typically recorded, such that they can be viewed by employees as a refresher, or if a given employee was not able to attend the meeting, that employee can catch up on a missed meeting at their convenience. Because remote working has become common place, there are a large number of recordings available for playback.

A common issue stemming from a recorded web-based meeting, is that a question may be asked during the meeting, in which the proper answer may only be provided by another person/user/employee that is not present online during the recording of the meeting. In many instances, this question may go unanswered. Or in some cases, the question will be answered directly by sending a communication (e.g., via email, direct messaging, phone call, etc.) to the attendee that asked the question by the person offline at a later date. However, the answer may never be disseminated post-meeting/recording to the attendees or further viewers of the recorded playback of the meeting.

### SUMMARY

Embodiments of the present disclosure include a method, system, and computer program product for augmenting an audio and/or video recording using an interaction platform. A processor may, in response to a playback by a user of a recording comprising at least one of an audio portion or a video portion, record an interaction of the user including at least one of asking a question or answering a question, during the playback to create a recorded interaction. The processor may combine the recorded interaction with a recent context of the recording of a predetermined duration as a memory aid to the user to create an augmented recording. The processor may store the augmented recording in a repository as a single playback subset to form an artifact. The processor may send a link to the artifact to a target audience of users using a predetermined method of communication associated with each respective user.

This is more advantageous over standard recording systems because it allows a user to generate recorded interactions (e.g., answering or asking a question, providing additional information, etc.) that provide further content to the original recording. This content may be stored as an artifact and sent via a link to a target audience in order to provide additional information to the target audience that was not included in the original recording.

In some embodiments, the processer may, in response to receiving input from at least one of the target audience of users having used the link to the artifact, determine whether to update the augmented recording in the repository. The processor may, in response to a determination to update the augmented recording in the repository, use the input received to create another single playback subset to form a second artifact. The processor may send a link to the second artifact to the target audience of users using the predetermined method of communication associated with each respective user. The processor may, in response to a determination to not update the augmented recording in the repository, send the input from the at least one of the target audience of users having used the link to the artifact directly to an author of the interaction.

This is advantageous over standard recording systems that do not allow for additional dialogue/content between users to be added/augmented with the original recording once it has been completed. In this way, further information supplied by multiple users may be augmented and/or associated with the original recording at a later time.

In some embodiments, the processor may analyze, using a trained natural language processing model, the natural language content of the recording. The processor may detect, based on the analyzing, a request for a user to record an interaction. The processor may identify the user by searching a contact list that comprises a target audience of users. The processor may automatically send the request to record the interaction to the user using the predetermined method of communication associated with the user.

This is more advantageous over standard recording systems that fail to automatically identify requests for a user to provide further information by analyzing the content of the recording itself. Rather, the proposed system uses natural language processing to automatically detect if a request for a user to record an interaction was made during the original recording. Once detected, the system automatically notifies the specific user, such that any missing or additional content can be supplied to augment the recording.

In some embodiments, the processor may identify a time point in the recording where a request for a user to record an interaction was made. This is advantageous because the system identifies where/when the request was made in the original recording so that the specific user can determine what type of information or content was requested of them.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example recording interaction system, in accordance with embodiments of the present disclosure.

FIG. 2 illustrates an example process for augmenting an audio and/or video recording using a recording interaction tool, in accordance with embodiments of the present disclosure.

FIG. 3 illustrates an example process for detecting a request for a recorded interaction, in accordance with embodiments of the present disclosure.

FIG. 4 illustrates a block diagram of an example natural language processing system, in accordance with some embodiments of the present disclosure.

FIG. 5 illustrates a high-level block diagram of an example computer system that may be used in implementing one or more of the methods, tools, and modules, and any related functions, described herein, in accordance with embodiments of the present disclosure.

FIG. 6 depicts a schematic diagram of a computing environment for executing program code related to the methods disclosed herein and for recording interactions for augmenting original recordings, according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to the field of audio and/or video recordings and, more particularly, to augmentation of an audio and/or video recording using an interaction platform. While the present disclosure is not necessarily limited to such applications, various aspects of the disclosure may be appreciated through a discussion of various examples using this context.

With the advent of remote working opportunities, web-based meetings and/or virtual conferencing have become a ubiquitous occurrence for many workers. In most instances, these web-based meetings are typically recorded, such that they can be viewed by employees as a refresher, or if a given employee was not able to attend the meeting, that employee can catch up on a missed meeting at their convenience. Because remote working has become common place, there are a large amount of recordings available for playback.

A common issue stemming from a recorded web-based meeting, is that a question may be asked during the meeting, in which the proper answer may only be provided by another person/user/employee that is not present/online during the recording of the meeting. In many instances, this question may go unanswered. Or in some cases, the question will be answered directly (e.g., via email, direct messaging, phone call, etc.) by a communication to the meeting attendee that asked the question by the person offline at a later date. However, the answer may never be disseminated post-meeting to the attendees or further viewers of the recorded playback of the meeting.

In most cases, it may not be clear to a user(s) or non-attendee on how to respond to questions and/or provide additional content to a web-based meeting if they missed the meeting. For example, if a user is watching a recording of a meeting and hears (or reads via closed captions) that someone said, “We need to ask the specific user if he agrees with this statement.” In response, that user would need to find a way to contact the speaker of the recording and provide not only the answer to the question, but most likely additional context on what the question was to refresh the speaker's memory (e.g., “During meeting XYZ you asked about statement ABC.”).

Unfortunately, there are many challenges with this scenario. For example, the user may not know whether to contact only the speaker(s) or host of the meeting, or whether they should contact everyone that attended the web-based meeting. Another issue may be that the user may not know if they should directly email the host, speaker(s), or all attendees rather than just directly messaging the host or the person that asked the initial question because they are unsure of communication preferences. Another common issue is that when the user responds with the answer to the question offline at a later date, the other person(s) that asked the question during the web-based meeting may not remember the context of the meeting. Lastly, in most instances, the recording of the web-based meeting may not be updated with the answer. Therefore, any viewers of the recording will never know what the answer to the question was, which may prevent them from learning an important aspect of the meeting and/or contributing to the substances of the meeting at a later date.

Embodiments of the present disclosure include a method, recording interaction system, and computer program product that allow a user to record an interaction (e.g., such as asking a question, answering a question, providing additional content, etc.) in response to playback of a recording (e.g., a meeting or presentation). The recorded interaction may be combined with recent context of the recording (e.g., such as a predetermined duration at the end of the recorded meeting or at a given interval within the recorded meeting) so that the requested user (or receiver) providing the recorded interaction may refresh their memory on the given subject of the meeting requiring additional content. Further, the recorded interaction may allow other users (e.g., a second user or sender) to interact with the recorded interaction such that a discourse or discussion between relevant users (sender and receiver of the interaction) may be generated and added to the content of the recorded meeting. In this way, a user or users that may not be present during the recorded meeting, may provide additional input when needed, allowing other users that view the recording at a later time to gain further insights to questions asked during the recorded meeting that typically may go unanswered.

In embodiments, the recording may be any type of recorded content such as audio content, video content, static image content (e.g., textual content of a presentation), and/or any combination thereof. The recording content may be generated from one or more recording devices (e.g., computers, smartphones, microphones, etc.). For example, the recording may be a web-based meeting or virtual conferencing session that includes a plurality of attendees that interact over a network.

In embodiments, the recording interaction system may allow attendees of a meeting and/or a target audience of users (e.g., which may include users that did not attend the meeting) to opt-in to post-meeting interactions. The target audience may be public (e.g., available to any user watching the playback of the recorded meeting) or private (only a select set of users or attendees) such that the given user types may only provide post-meeting interactions. Attendees and/or the target audience of users may choose a predetermined method of communication that allows the system to communicate with the given user(s) a request for new or additional content to be generated for a given recording. The users may determine to be contacted using various communication types such as direct messaging, email, text messaging, voicemail, automated calling, and the like. The system may contact various users or attendees using a contact list that includes contact information and/or preferences for users that have opted-in to the post-meeting interactions. Further the system may communicate to the attendees and/or users a notification that new content to a recording (e.g., augmented recording) may be available once an interaction has been generated. In this way, attendees or viewers of a recording may be notified when the recorded meeting has been updated with answers and/or questions that were not included with the original content.

In embodiments, the recording interaction system may allow any users or attendees to provide additional content to the recording via a recorded interaction. The recorded interaction may be any type of user interaction that provides additional information to the recording. For example, the recorded interaction may be a user answering a question that was asked during a recorded meeting that went unanswered. In another example, the recorded interaction may be a user asking an additional question(s) that was not asked during a meeting, where a second user may supply the answer via a second recorded interaction, where both interactions are augmented (added, merged, associated via an artifact link, etc.) with the original recording. In embodiments, the recorded interaction may be in the form of written content, audio content, video content, or any combination thereof.

In embodiments, once the recorded interaction is generated by the given user or users, the recording interaction system may combine the recorded interaction with a predetermined portion or context of the original recording. For example, the recorded interaction may be added to a 10 second clip of the question being asked in the original recording such that the user providing the interaction and/or users viewing the interaction may refresh their memories as to the question that is being answered in the interaction. In some embodiments, the recorded interaction may be merged or edited with the original recording (e.g., added to the end of the recording). In some embodiments, the recorded interaction(s) may be stored as a single viewable playback subset, and a link to that given artifact is sent to the target audience of users or attendees via their specified method of communication. In this way, that target audience of users may be notified that the new interaction content is available and may require additional viewing and/or feedback from the target audience of users.

In embodiments, the receiver or viewer of the recorded interaction may be given an option to record their own interaction in response. For example, a first recorded interaction may contain a question posed by a first user that was provided after watching a recorded meeting, while a second recorded interaction may include the answer to the question given by a second user that was prompted by the system to view the first interaction via their specified communication method. In embodiments, both the first and second recorded interactions may be augmented with the original recorded meeting (e.g., merged with or a subset of single viewable playback links) such that they are available for viewing by the target audience. In some embodiments, uploading of a recorded interaction may be open to any users if the recording or meeting is classified as public. In some embodiments, uploading of a recorded interaction may require approval if the recorded meeting is classified as private. For example, an owner or author of the recording and/or initial recorded interaction may approve/disapprove additional recorded interactions to be augmented with a given recording if the meeting is private.

In some embodiments, the recording interaction system may train a natural language processing model to analyze natural language content of the recording and identify if a request for a recorded interaction was made during the recording. For example, the natural language processing model may be trained to identify various phrases from audio content of the recording that indicate a user has been requested to answer a question or provide feedback. In some embodiments, the natural language processing model may generate a transcript (e.g., closed captions) from the recording and perform a contextual analysis on the transcript. The natural language processing model may identify that a specific user's name was stated along with a phrase (e.g., a phrase such as, “We need more information from John Smith.”) seeking more information during a recorded meeting. The natural language processing model may search a contact list of target audience users and/or attendees and automatically send a notification to the specific user that was identified in the recording requesting a recorded interaction to provide the additional information. In some embodiments, the natural language processing model may include a time point indicating where/when the request was made in the original recording, or a clip or link to playback of the question being asked that was generated by the recording interaction system. This may be used to provide the specific user context of the request for the recorded interaction.

The aforementioned advantages are example advantages, and not all advantages are discussed. Furthermore, embodiments of the present disclosure can exist that contain all, some, or none of the aforementioned advantages while remaining within the spirit and scope of the present disclosure.

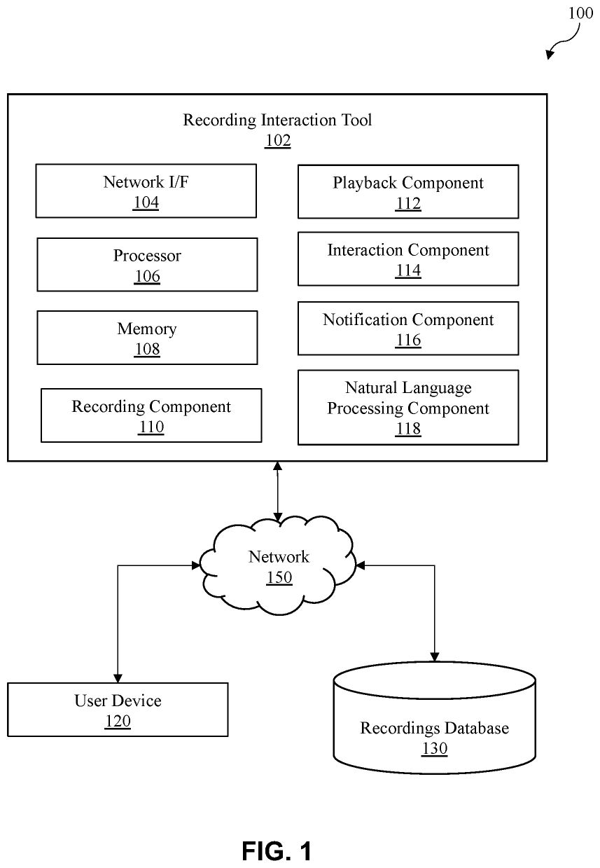

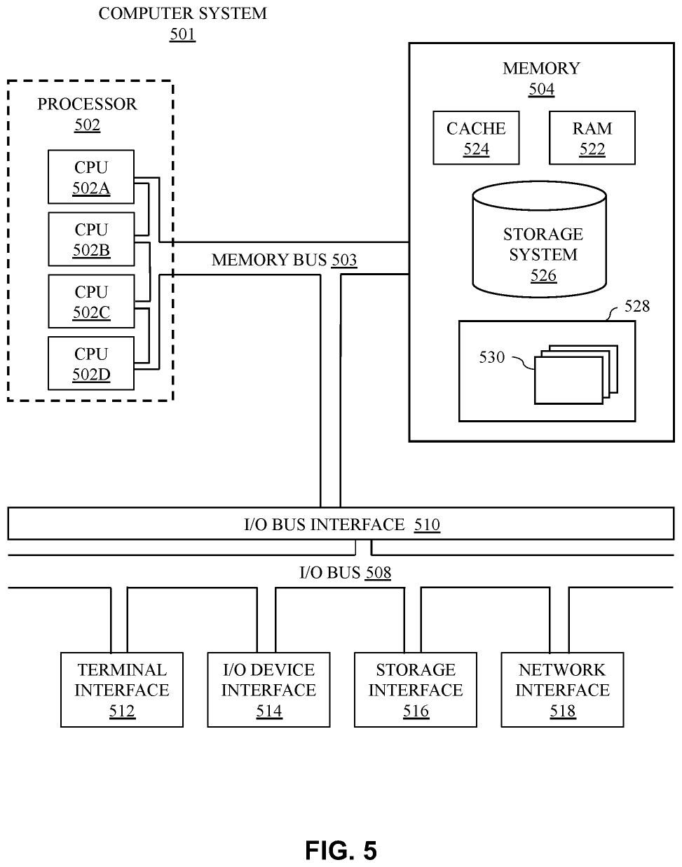

With reference now to FIG. 1, shown is a block diagram of an example recording interaction system 100, in accordance with embodiments of the present disclosure. In the illustrated embodiment, recording interaction system 100 includes recording interaction tool 102 that is communicatively coupled to user device 120 and recordings database via network 150. Recording interaction tool 102, user device 120, and recordings database 130 may be configured as any type of computer system and may be substantially similar to computer system 501 of FIG. 5. In some embodiments, recording interaction tool 102, user device 120, and recordings database 130 may be configured as separate standalone systems or as one or more integrated system. For example, recording interaction tool 102 and recordings database 130 may be included with user device 120 as an integrated system (e.g., applications on a smartphone or computer). In some embodiments, each device may be separate and communicatively connected to each other over network 150.

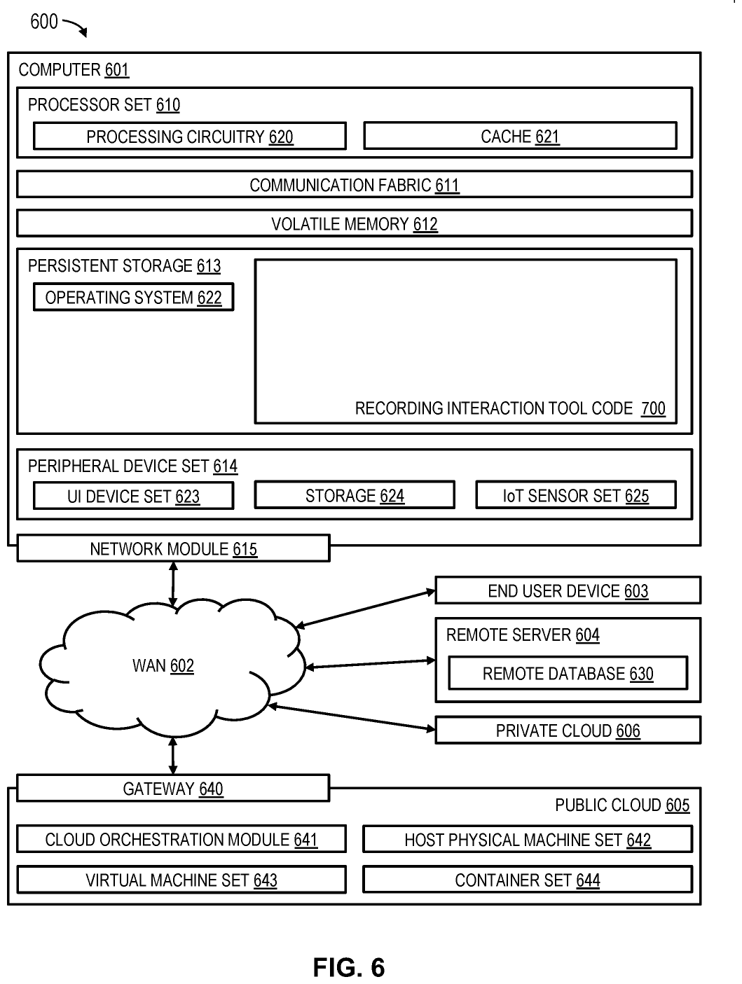

Network 150 may be any type of communication network, such as a wireless network or a cloud computing network. Network 150 may be substantially similar to, or the same as, a computing environment 600 described in FIG. 6. In some embodiments, network 150 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over network 150. In some embodiments, network 150 can be implemented using any number of any suitable communications media. For example, the network may be a wide area network (WAN), a local area network (LAN), a personal area network (PAN), an internet, or an intranet. In certain embodiments, the various systems may be local to each other, and communicate via any appropriate local communication medium. For example, recording interaction tool 102 may communicate with user device 120 and recordings database 130, using a WAN, one or more hardwire connections (e.g., an Ethernet cable), and/or wireless communication networks. In some embodiments, the various systems may be communicatively coupled using a combination of one or more networks and/or one or more local connections. For example, in some embodiments, recording interaction tool 102 (e.g., application on a server) may communicate with recordings database 130 using a hardwired connection, while communication between user device 120 (e.g., smartphone, tablet, etc.) and recording interaction tool 102 may be through a wireless communication network.

In embodiments, user device 120 may be any type of computing device (e.g., smartphone, tablet, personal computer, Internet of Things (IoT) camera, video camera, augmented reality device, etc.) that is configured to view playback of recording and/or generate a recorded interaction (e.g., audio content, video content, or both). In some embodiments, user device 120 and recordings database 130 may include some or similar components (e.g., processor, memory, network I/F, etc.) as recording interaction tool 102, but for brevity purposes these components are not shown.

In the illustrated embodiment, recording interaction tool 102 includes network interface (I/F) 104, processor 106, memory 108, recording component 110, playback component 112, interaction component 114, notification component 116, and natural language processing system 118. In embodiments, recording component 110 is configured to generate recordings (e.g., audio, video, combination of both) of various meetings or presentations attended by a plurality of users. For example, a recording may be generated for a web-based meeting between the plurality of users that are connected over a network, a live meeting that is attended in person by the plurality of users, and/or a single user presentation. It is noted that these examples of recordings are not meant to be limiting and that other types of recordings may be used as would be recognized by one skilled in the art. The generated recordings may be stored and/or accessed via recordings database 130. Further, user preferences related to recordings and/or post-meeting interactions may be stored on recordings database 130. For example, attendees and/or the target audience of users may choose a predetermined method of communication preference that allows the recording interaction tool 102 to communicate with the given user(s) a request for new or additional content to be generated for a given recording. In embodiments, notification component 116 may be configured to notify and/or contact users using various communication types such as direct messaging, email, text messaging, voicemail, automated calling, and the like. Notification component 116 may contact various users or attendees using a contact list that includes contact information and/or preferences for users that have opted-in to the post-meeting interactions.

In embodiments, playback component 112 is configured to initiate playback of a given recording when accessed/viewed by a user. Playback component 112 may access recordings on recording database 130. In embodiments, interaction component 114 is configured to generate a recorded interaction by a user and augment a recording with the recorded interaction. In some embodiments, interaction component 114 may combine the interaction with a predetermined portion or context of the original recording. For example, the recorded interaction may be added to a 20 second clip of a question being asked in the original recording (recorded meeting) such that the user providing the interaction and/or users viewing the interaction may refresh their memories of the question that is being answered in the interaction. In some embodiments, interaction component 114 may merge/edit the recorded interaction with the original recording (e.g., added to the end of the recording, middle, etc.). In some embodiments, interaction component 114 may store the recorded interaction(s) as a single viewable playback subset associated with the recording within recordings database 130. Interaction component 114 may generate a link to that given artifact, where notification component 116 sends the link to the target audience of users or attendees via their specified method of communication. In this way, that target audience of users may be notified that the new interaction content is available and may require additional viewing and/or feedback from the target audience of users.

In some embodiments, interaction component 114 is configured to generate recorded interactions of additional responses (a second recorded interaction) to the recording or to prior recorded interactions (a first recorded interaction). For example, a plurality of recorded interactions may be generated by various user when having a dialogue on a given subject, wherein each recorded interaction may be merged with the original recording or added as a subset of single viewable playback links with the original recording such that they are available for viewing by the target audience.

In some embodiments, natural language processing component 118 may train a natural language processing model to analyze natural language content of the recording and identify if a request for a recorded interaction was made during the recording. In some embodiments, natural language processing component 118 may generated training data from a plurality of sample recordings that include a plurality of sample requests for additional recorded interactions. For example, the natural language processing model may be trained to identify various phrases that indicate a specific user (non-attendee) has been requested by another user (attendee) to answer a question or provide feedback. Once trained, natural language processing component 118 may identify that the specific user's name was stated along with a phrase seeking more information during a recorded meeting. Natural language processing component 118 may search a contact list of target audience users and/or attendees shown to be in attendance to identify the specific user's contact information and preferences who is identified as not attending the meeting. Once identified, notification component 116 may automatically send a notification to the specific user that was identified in the recording a request for a recorded interaction to provide the additional information.

FIG. 1 is intended to depict the representative major components of recording interaction system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with recording interaction system 100 may not be present, and the arrangement of components may vary. For example, while FIG. 1 illustrates an example recording interaction system 100 having a single recording interaction tool 102, a single user device 120, and a single recordings database 130 that are communicatively coupled via a single network 150, suitable network architectures for implementing embodiments of this disclosure may include any number of recording interaction tools, user devices, databases, and networks. The various models, modules, systems, and components illustrated in FIG. 1 may exist, if at all, across a plurality of recording interaction tools, user devices, databases, and networks.

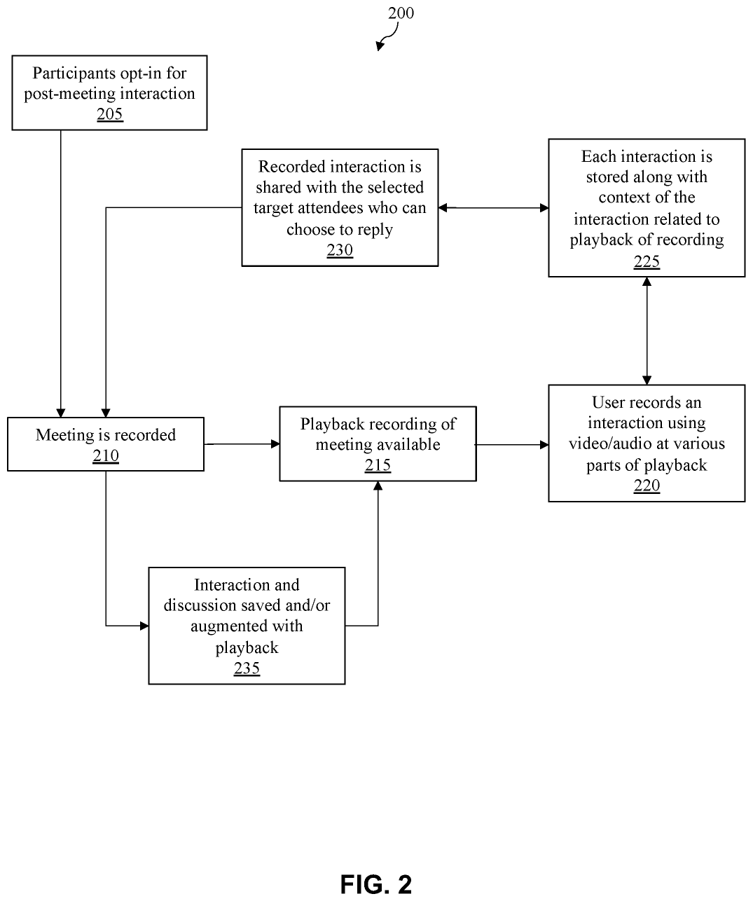

Referring now to FIG. 2, shown is an example process 200 for augmenting an audio and/or video recording using an interaction tool, in accordance with embodiments of the present disclosure. The process 200 may be performed by processing logic that comprises hardware (e.g., circuitry, dedicated logic, programmable logic, microcode, etc.), software (e.g., instructions run on a processor), firmware, or a combination thereof. In some embodiments, the process 200 is a computer-implemented process. In embodiments, the process 200 may be performed by processor 106 of recording interaction tool 102 exemplified in FIG. 1.

In some embodiments, the process 200 begins by a user or meeting attendee opting into post-meeting interactions. This is shown at step 205. Each participant of a given recorded meeting may choose notification preferences for post-meeting interactions (e.g., email, text, direct message, etc.). For example, the participant may choose to be notified by email or direct message that a request for a recorded interaction with the recorded meeting is requested/required.

The process 200 continues by recording a meeting. This is shown at step 210. For example, a web-based meeting or virtual conference may be recorded where both audio, video, textual content, or any combination thereof, are generated for the given meeting.

The process 200 continues storing the recording of the meeting such that playback of the meeting is available to one or more users. This is shown at step 215. For example, a video recording of the meeting may be stored in a recordings corpus/database where it is available for playback (e.g., streaming playback, download, etc.). The recording or recorded meeting may include one or more requests for interaction from a second user (e.g., non-attendee) that may not be present at the meeting. For example, the request for interaction may be in the form of a question such as someone in the meeting asking, “Maybe we should ask John Smith to answer this question?”.

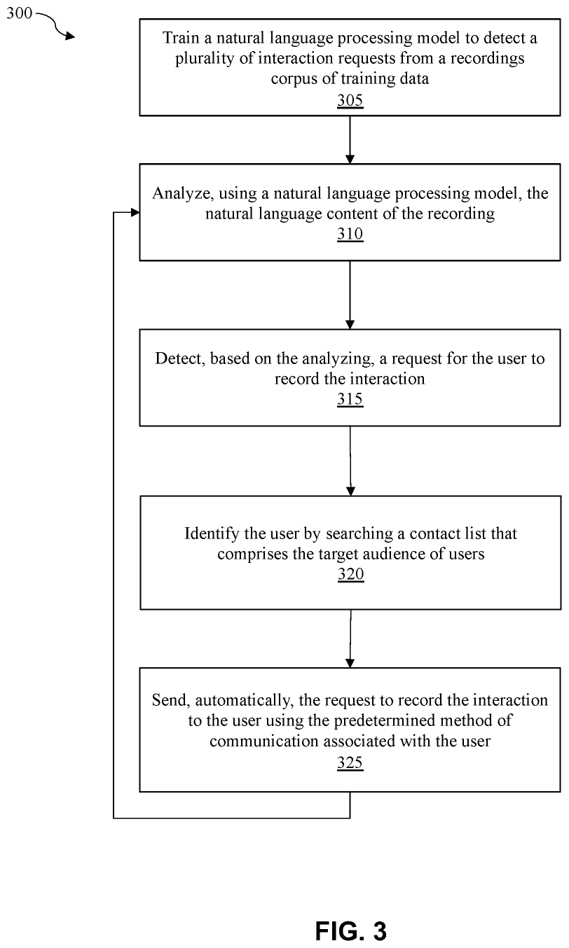

The process 200 continues in response to a playback by a user of the recording, comprising at least one of an audio portion and/or a video portion, recording an interaction of the user including at least one of asking a question, and/or answering a question, during the playback to create a recorded interaction. This is illustrated at step 220. For example, the user may have received a request to provide an answer to a question that was asked in the meeting that went unanswered. The request may be sent manually to the user by a meeting attendee or meeting administrator or sent automatically by the interaction tool itself (this process 300 is detailed in FIG. 3).

The process 200 continues by combining the recorded interaction with a recent context of the recording of a predetermined duration as a memory aid to the user to create an augmented recording. This is shown at step 225. Once combined, the augmented recording may be stored in a repository as a single playback subset to form an artifact.

The process 200 continues by sending a link to the artifact to a target audience of users using a predetermined method of communication associated with each respective user. This is shown at step 230. For example, the recorded interaction is shared with other users (meeting attendees and/or target audience users that were not at the meeting) so that they may choose to reply to the recorded interaction. The author of the first recorded interaction can choose to update the recorded interaction with input (or a second recorded interaction) collected from the other users.

For example, in some embodiments, in response to receiving input from at least one of the target audience of users having used the link to the artifact, a determination can be made whether to update the augmented recording in the repository. In response to a determination to update the augmented recording in the repository, the user may use the input received to create another single playback subset to form a second artifact. Once the second artifact is generated a link to the second artifact may be sent to the target audience of users using the predetermined method of communication associated with each respective user. This allows for a discourse or dialogue to be discussed between target users such that they can answer/discuss various content to be added to the original recording. In response to a determination to not update the augmented recording in the repository (no more input or secondary input is required for augmenting the recording), sending the input from the at least one of the target audience of users having used the link to the artifact directly to an author of the interaction. In this way, the author or user who generated the initial recorded interaction can determine what input to include or augment the recording with.

The process 200 continues by saving and/or augmented the recorded interaction(s) with the original recording for playback. This is illustrated at step 235. In some embodiments, the interaction tool may combine the recorded interaction(s) with a predetermined portion or context of the original recording. For example, the recorded interaction may be added to a 15 second clip of a question being asked in the original recording (or recorded meeting) such that the user providing the interaction and/or users viewing the interaction may refresh their memories of the question that is being answered in the recorded interaction. In some embodiments, the recorded interaction may be merged, augmented, or edited with the original recording (e.g., added to the end of the recording). In some embodiments, the recorded interaction(s) may be stored as a single viewable playback subset, and a link to that given artifact is sent to the target audience of users or attendees via their specified method of communication. In this way, that target audience of users may be notified that the new interaction content is available and may require additional viewing and/or feedback from the target audience of users.

Referring now to FIG. 3, shown is a flow diagram of an example process 300 for detecting a request for a recorded interaction, in accordance with embodiments of the present disclosure. The process 300 may be performed by processing logic that comprises hardware (e.g., circuitry, dedicated logic, programmable logic, microcode, etc.), software (e.g., instructions run on a processor), firmware, or a combination thereof. In some embodiments, the process 300 may be a sub-process that is in addition to process 200. In some embodiments, the process 300 is a computer-implemented process. In embodiments, the process 300 may be performed by processor 106 of recording interaction tool 102 exemplified in FIG. 1.

In some embodiments, the process 300 begins by training a natural language processing model to detect a plurality of recorded interaction requests from a recording corpus of training data. This is illustrated at step 305. The training data may comprise prior recordings that include identified phrases that indicate a request for a recorded interaction has been made. For example, phrases such as, “We should ask John Smith about this subject” or “John Smith is the manager of that project, we may need more information from him” and the like, may be detected and identified by the trained model as a request for a recorded interaction from John Smith.

The process 300 continues by analyzing, using the natural language processing model, the natural language content of the recording. This is illustrated at step 310. Once the system is trained it may be used to analyze new or modified recordings to determine if any requests for recorded interactions are present. For example, the natural language processing model may be trained to identify various phrases from audio content of the recording that indicate a user has been requested to answer a question or provide feedback. In some embodiments, the natural language processing model may generate a transcript from the recording and perform a contextual analysis on the transcript. In some embodiments, the natural language processing model may include a time point or pointer indicating where the request was made in the original recording, or a clip or link to playback of the question being asked that was generated by the recording interaction tool. This may be used to provide the specific user context of the request for the recorded interaction.

In some embodiments, if no requests for a recorded interaction are found by the model, a user may be requested to do a manual detection/identification, to be sure none were missed. Over time, the model may use machine learning and/or a feedback mechanism to improve accuracy on detecting request that are made by analyzing further recordings that may include manual identification of requests. In this way, the natural language processing model may improve its predications as the model ingests more data.

The process 300 continues by detecting, based on the analyzing, a request for the user to record the interaction. This is illustrated at step 315. The natural language processing model may identify that a specific user's name was stated along with a phrase seeking more information during a recorded meeting (e.g., a phrase such as, “We need Jane Doe to answer that question when she gets back from vacation”).

The process 300 continues by identifying the user by searching a contact list that comprises the target audience of users. This is illustrated at step 320. For example, the target audience of users would likely include the identified user's contact information (e.g., email, direct message profile information, phone number, etc.) as gathered at the user opt-in state for post-meeting interactions.

The process 300 continues by sending, automatically, the request to record the interaction to the user using the predetermined method of communication associated with the user. This is illustrated at step 325. For example, once the user has been identified, the interaction tool may automatically send a user a notification requesting that the user provide the recorded interaction to be augmented with the recording. In this way

In some embodiments, the process 300 returns to step 310. For example, the natural language processing model will continuously analyze the content of the recording and/or augmented recording includes subsequent recorded interaction to determine if any additional requests for recorded interactions are made. In this way, any identified users will be notified that additional content is requested from them.

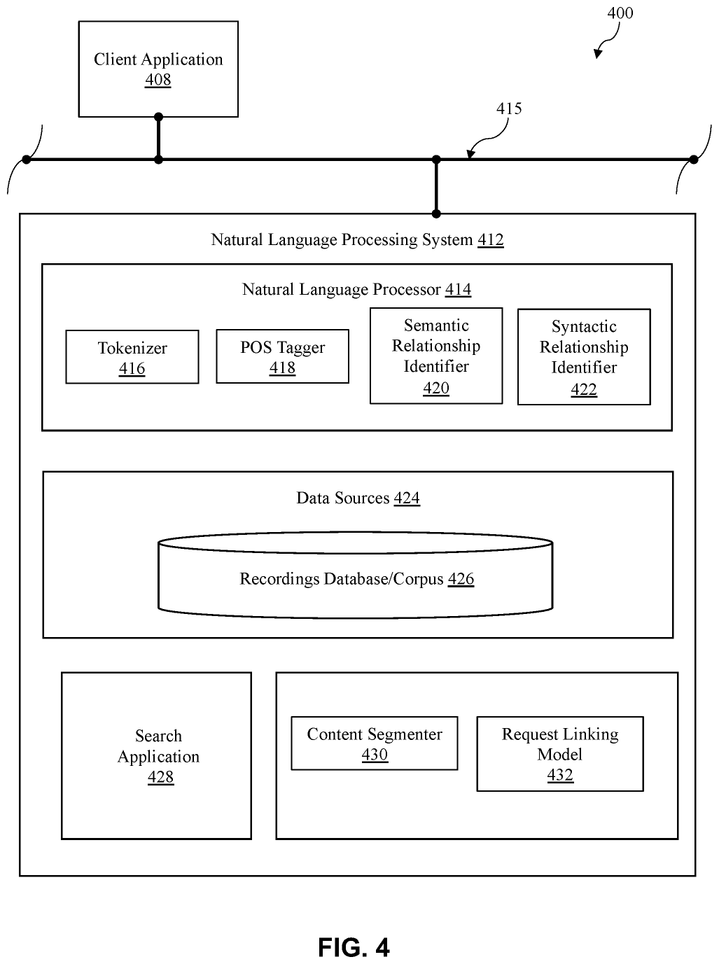

Referring now to FIG. 4, shown is a block diagram of an exemplary system architecture 400, including a natural language processing system 412, in accordance with some embodiments of the present disclosure. In embodiments, natural language processing system 412 is configured to analyze audio and textual content (e.g., dialogue, conversation threads, utterances, etc.) collected from recording to determine if a request for a recorded interaction has been made. In embodiments, natural language processing system 412 may be the same or substantially similar to natural languages processing component 118 which is housed on recording interaction tool 102 of FIG. 1. In some embodiments, the recording interaction tool 102 may include a client application 408, which may be used to initiate collecting and analyzing the recordings stored on recording database/corpus 426 over network 415.

Consistent with various embodiments, the natural language processing system 412 may respond to demands for detecting requests for recorded interaction generation functions initiated by the client application 408. Specifically, the natural language processing system 412 may analyze audio and/or textual transcripts of recordings in order to extract contextual information to identify if various requests for recorded interactions were made for specific user within the recording. In some embodiments, the natural language processing system 412 may include a natural language processor 414, data sources 424, a search application 428, content segmenter 430, and relationship labeler 432. The natural language processor 414 may be a computer module that analyzes the recording transcripts, recorded audio, semantic structures, dialogues, conversation threads, utterance data, associated metadata, unstructured data, etc. The natural language processor 414 may perform various methods and techniques for analyzing the contextual data of the recording (e.g., syntactic analysis, semantic analysis, etc.) in order to make predictions related to detecting requests for recorded interaction from users. The natural language processor 414 may be configured to recognize and analyze any number of natural languages. In some embodiments, the natural language processor 414 may parse textual content of the recording and audio dialogue data. Further, the natural language processor 414 may include various modules to perform analyses of textual and/or transcripts of the audio data. These modules may include, but are not limited to, a tokenizer 416, a part-of-speech (POS) tagger 418, a semantic relationship identifier 420, and a syntactic relationship identifier 422.

In some embodiments, the tokenizer 416 may be a computer module that performs lexical analysis. The tokenizer 416 may convert a sequence of characters into a sequence of tokens. A token may be a string of characters included in an electronic document (text document, spreadsheet, webpage, etc.) and categorized as a meaningful symbol. Further, in some embodiments, the tokenizer 416 may identify word boundaries in an electronic document and break any text passages within the document into their component text elements, such as words, multiword tokens, numbers, and punctuation marks. In some embodiments, the tokenizer 416 may receive a string of characters, identify the lexemes in the string, and categorize them into tokens.

Consistent with various embodiments, the POS tagger 418 may be a computer module that marks up a word in passages to correspond to a particular part of speech. The POS tagger 418 may read a passage or other text in natural language and assign a part of speech to each word or other token. The POS tagger 418 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed electronic documents (e.g., the content of one article on an entity may shed light on the meaning of text elements in another article on the same entity, particularly if they are part of the same corpus or universe). Examples of parts of speech that may be assigned to words include, but are not limited to, nouns, verbs, adjectives, adverbs, and the like. Examples of other part of speech categories that POS tagger 418 may assign include, but are not limited to, comparative or superlative adverbs, wh-adverbs, conjunctions, determiners, negative particles, possessive markers, prepositions, wh-pronouns, and the like. In some embodiments, the POS tagger 418 may tag or otherwise annotate tokens of a passage with part of speech categories. In some embodiments, the POS tagger 418 may tag tokens or words of a passage to be parsed by the natural language processing system 412.

In some embodiments, the semantic relationship identifier 420 may be a computer module that may be configured to identify semantic relationships of recognized text elements (e.g., words, phrases) in the textual content and/or transcripts of the audio content/conversation threads. In some embodiments, the semantic relationship identifier 420 may determine functional dependencies between entities and other semantic relationships.

Consistent with various embodiments, the syntactic relationship identifier 422 may be a computer module that may be configured to identify syntactic relationships in a passage composed of tokens. The syntactic relationship identifier 422 may determine the grammatical structure of sentences such as, for example, which groups of words are associated as phrases and which word is the subject or object of a verb. The syntactic relationship identifier 422 may conform to formal grammar.

In some embodiments, the natural language processor 414 may be a computer module that may parse textual data of a transcript of a recording to identify a request for a recorded interaction for a specific user to provide content on a given topic based on an overall analysis of the recording.

In some embodiments, the output of the natural language processor 414 may be stored as an information on recordings database/corpus 426 in one or more data sources 424. In some embodiments, data sources 424 may include data warehouses, information corpora, data models, and recording repositories. The recordings database/corpus 426 may enable data storage and retrieval. In some embodiments, the recordings database/corpus 426 may be a storage mechanism that houses a standardized, consistent, clean, and integrated copy of the ingested and parsed transcript of audio content and/or dialogue data used to generate confidence values related to predictions for detection of requests for recorded interactions. Data stored in the recordings database/corpus 426 may be structured in a way to specifically address analytic requirements. In some embodiments, the recordings database/corpus 426 may be a relational database.

In some embodiments, the natural language processing system 412 may include a content segmenter 430. The content segmenter 430 may be a computer module that is configured to determine relevant content of the recording by analyzing the semantic structure of the textual content (e.g., transcript of the audio content) and segmenting the content to be used for identifying what type of request for a recorded interaction was made (e.g., provide an answer, follow up question on a topic, request a dialogue between users, etc.). In some embodiments, the natural language processing system 412 may include a request linking model 432 that is configured to identify specific users from the recording and link that given user to the identified request for generating a recorded interaction. In some embodiments, the request linking model 432 may identify more than one user if contextual data and/or content indicate more than one user is required to provide further content to the recording.

Referring now to FIG. 5, shown is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache. In some embodiments, a processor can include at least one or more of, a memory controller, and/or storage controller. In some embodiments, the CPU can execute the processes included herein (e.g., process 200 and 300 as described in FIG. 2 and FIG. 3, respectively). In some embodiments, the computer system 501 may be configured as recording interaction system 100 of FIG. 1.

System memory subsystem 504 may include computer system readable media in the form of volatile memory, such as random-access memory (RAM) 522 or cache memory 524. Computer system 501 may further include other removable/non-removable, volatile/non-volatile computer system data storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 504 can include flash memory, e.g., a flash memory stick drive or a flash drive. Memory devices can be connected to memory bus 503 by one or more data media interfaces. The memory subsystem 504 may include at least one program product having a set (e.g., at least one) of program modules that are configured to carry out the functions of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single units, the computer system 501 may, in some embodiments, contain multiple I/O bus interfaces 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface but receives requests from other computer systems (clients). Further, in some embodiments, the computer system 501 may be implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

One or more programs/utilities 528, each having at least one set of program modules 530 may be stored in memory subsystem 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 528 and/or program modules 530 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Embodiments of the present disclosure may be implemented together with virtually any type of computer, regardless of the platform is suitable for storing and/or executing program code. FIG. 6 shows, as an example, a computing environment 600 (e.g., cloud computing system) suitable for executing program code related to the methods disclosed herein and for circuit design automation. In some embodiments, the computing environment 600 may be the same as or an implementation of the computing environment 100.

Computing environment 600 contains an example of an environment for the execution of at least some of the computer code involved in performing the inventive methods, such as recording interaction tool code 700. The recording interaction tool code 700 may be a code-based implementation of the autonomous vehicle management system 100. In addition to recording interaction tool code 700, computing environment 600 includes, for example, a computer 601, a wide area network (WAN) 602, an end user device (EUD) 603, a remote server 604, a public cloud 605, and a private cloud 606. In this embodiment, the computer 601 includes a processor set 610 (including processing circuitry 620 and a cache 621), a communication fabric 611, a volatile memory 612, a persistent storage 613 (including operating a system 622 and the recording interaction tool code 700, as identified above), a peripheral device set 614 (including a user interface (UI) device set 623, storage 624, and an Internet of Things (IoT) sensor set 625), and a network module 615. The remote server 604 includes a remote database 630. The public cloud 605 includes a gateway 640, a cloud orchestration module 641, a host physical machine set 642, a virtual machine set 643, and a container set 644.

The computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 630. As is well understood in the art of computer technology, and depending upon the technology, performance of a computer-implemented method may be distributed among multiple computers and/or between multiple locations. On the other hand, in this presentation of the computing environment 600, detailed discussion is focused on a single computer, specifically the computer 601, to keep the presentation as simple as possible. The computer 601 may be located in a cloud, even though it is not shown in a cloud in FIG. 1. On the other hand, the computer 601 is not required to be in a cloud except to any extent as may be affirmatively indicated.

The processor set 610 includes one, or more, computer processors of any type now known or to be developed in the future. The processing circuitry 620 may be distributed over multiple packages, for example, multiple, coordinated integrated circuit chips. The processing circuitry 620 may implement multiple processor threads and/or multiple processor cores. The cache 621 is memory that is located in the processor chip package(s) and is typically used for data or code that should be available for rapid access by the threads or cores running on the processor set 610. Cache memories are typically organized into multiple levels depending upon relative proximity to the processing circuitry. Alternatively, some, or all, of the cache for the processor set may be located “off chip.” In some computing environments, the processor set 610 may be designed for working with qubits and performing quantum computing.

Computer readable program instructions are typically loaded onto the computer 601 to cause a series of operational steps to be performed by the processor set 610 of the computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 621 and the other storage media discussed below. The program instructions, and associated data, are accessed by the processor set 610 to control and direct performance of the inventive methods. In the computing environment 600, at least some of the instructions for performing the inventive methods may be stored in the recording interaction tool code 700 in the persistent storage 613.

The communication fabric 611 is the signal conduction path that allows the various components of the computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In the computer 601, the volatile memory 612 is located in a single package and is internal to the computer 601, but, alternatively or additionally, the volatile memory may be distributed over multiple packages and/or located externally with respect to the computer 601.

The persistent storage 613 is any form of non-volatile storage for computers that is now known or to be developed in the future. The non-volatility of this storage means that the stored data is maintained regardless of whether power is being supplied to the computer 601 and/or directly to the persistent storage 613. The persistent storage 613 may be a read only memory (ROM), but typically at least a portion of the persistent storage allows writing of data, deletion of data and re-writing of data. Some familiar forms of persistent storage include magnetic disks and solid state storage devices. The operating system 622 may take several forms, such as various known proprietary operating systems or open source Portable Operating System Interface-type operating systems that employ a kernel. The code included in the recording interaction tool code 700 typically includes at least some of the computer code involved in performing the inventive methods.

The peripheral device set 614 includes the set of peripheral devices of the computer 601. Data communication connections between the peripheral devices and the other components of the computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 623 may include components such as a display screen, speaker, microphone, wearable devices (such as goggles and smart watches), keyboard, mouse, printer, touchpad, game controllers, and haptic devices. The storage 624 is external storage, such as an external hard drive, or insertable storage, such as an SD card. The storage 624 may be persistent and/or volatile. In some embodiments, the storage 624 may take the form of a quantum computing storage device for storing data in the form of qubits. In embodiments where the computer 601 is required to have a large amount of storage (for example, where the computer 601 locally stores and manages a large database) then this storage may be provided by peripheral storage devices designed for storing very large amounts of data, such as a storage area network (SAN) that is shared by multiple, geographically distributed computers. The IoT sensor set 625 is made up of sensors that can be used in Internet of Things applications. For example, one sensor may be a thermometer and another sensor may be a motion detector.

The network module 615 is the collection of computer software, hardware, and firmware that allows the computer 601 to communicate with other computers through the WAN 602. The network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 615 are performed on the same physical hardware device. In other embodiments (for example, embodiments that utilize software-defined networking (SDN)), the control functions and the forwarding functions of the network module 615 are performed on physically separate devices, such that the control functions manage several different network hardware devices. Computer readable program instructions for performing the inventive methods can typically be downloaded to the computer 601 from an external computer or external storage device through a network adapter card or network interface included in the network module 615.

The WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 603 is any computer system that is used and controlled by an end user (for example, a customer of an enterprise that operates the computer 601) and may take any of the forms discussed above in connection with the computer 601. The EUD 603 typically receives helpful and useful data from the operations of the computer 601. For example, in a hypothetical case where the computer 601 is designed to provide a recommendation to an end user, this recommendation would typically be communicated from the network module 615 of the computer 601 through the WAN 602 to the EUD 603. In this way, the EUD 603 can display, or otherwise present, the recommendation to an end user. In some embodiments, the EUD 603 may be a client device, such as thin client, heavy client, mainframe computer, desktop computer and so on.

The remote server 604 is any computer system that serves at least some data and/or functionality to the computer 601. The remote server 604 may be controlled and used by the same entity that operates computer 601. The remote server 604 represents the machine(s) that collect and store helpful and useful data for use by other computers, such as the computer 601. For example, in a hypothetical case where the computer 601 is designed and programmed to provide a recommendation based on historical data, then this historical data may be provided to the computer 601 from the remote database 630 of the remote server 604.

The public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 605 is performed by the computer hardware and/or software of the cloud orchestration module 641. The computing resources provided by the public cloud 605 are typically implemented by virtual computing environments that run on various computers making up the computers of the host physical machine set 642, which is the universe of physical computers in and/or available to the public cloud 605. The virtual computing environments (VCEs) typically take the form of virtual machines from the virtual machine set 643 and/or containers from the container set 644. It is understood that these VCEs may be stored as images and may be transferred among and between the various physical machine hosts, either as images or after instantiation of the VCE. The cloud orchestration module 641 manages the transfer and storage of images, deploys new instantiations of VCEs and manages active instantiations of VCE deployments. The gateway 640 is the collection of computer software, hardware, and firmware that allows the public cloud 605 to communicate through the WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 606 is similar to the public cloud 605, except that the computing resources are only available for use by a single enterprise. While the private cloud 606 is depicted as being in communication with the WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 605 and the private cloud 606 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 622 and the recording interaction tool code 700 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for interacting with a recording, the method comprising:
in response to a playback by a user of the recording, comprising at least one of an audio portion or a video portion, recording an interaction of the user including at least one of asking a question or answering a question, during the playback to create a recorded interaction;
combining the recorded interaction with a recent context of the recording of a predetermined duration as a memory aid to the user to create an augmented recording;
storing the augmented recording in a repository as a single playback subset to form an artifact; and
sending a link to the artifact to a target audience of users using a predetermined method of communication associated with each respective user.

2. The method of claim 1, further comprising:
in response to receiving input from at least one of the target audience of users having used the link to the artifact, determining whether to update the augmented recording in the repository;
in response to a determination to update the augmented recording in the repository, using the input received to create another single playback subset to form a second artifact;
sending a link to the second artifact to the target audience of users using the predetermined method of communication associated with each respective user; and
in response to a determination to not update the augmented recording in the repository, sending the input from the at least one of the target audience of users having used the link to the artifact directly to an author of the interaction.

3. The method of claim 1, wherein the predetermined method of communication associated with each respective user is chosen from a group of communication types consisting of: direct messaging, email, text messaging, voicemail, and automated calling.

4. The method of claim 1, further comprising:
analyzing, using a natural language processing model, the natural language content of the recording;
detecting, based on the analyzing, a request for the user to record the interaction;
identifying the user by searching a contact list that comprises the target audience of users; and
sending, automatically, the request to record the interaction to the user using the predetermined method of communication associated with the user.

5. The method of claim 4, wherein the request to record the interaction includes a time point of the recording where the request to record the interaction was made.

6. The method of claim 4, further comprising:
training the natural language processing model to detect a plurality of interaction requests from a recording corpus of training data.

7. The method of claim 1, wherein the augmented recording is merged with the recording to create updated recording.

8. A system for interacting with a recording comprising:
a processor; and
a computer-readable storage medium communicatively coupled to the processor and storing program instructions which, when executed by the processor, cause the processor to perform a method comprising:
in response to a playback by a user of the recording, the recording comprising at least one of an audio portion or a video portion, recording an interaction of the user including at least one of asking a question or answering a question, during the playback to create a recorded interaction;
combining the recorded interaction with a recent context of the recording of a predetermined duration as a memory aid to the user to create an augmented recording;
storing the augmented recording in a repository as a single playback subset to form an artifact; and
sending a link to the artifact to a target audience of users using a predetermined method of communication associated with each respective user.

9. The system of claim 8, wherein the method performed by the processor further comprises:
in response to receiving input from at least one of the target audience of users having used the link to the artifact, determining whether to update the augmented recording in the repository;
in response to a determination to update the augmented recording in the repository, using the input received to create another single playback subset to form a second artifact;
sending a link to the second artifact to the target audience of users using the predetermined method of communication associated with each respective user; and
in response to a determination to not update the augmented recording in the repository, sending the input from the at least one of the target audience of users having used the link to the artifact directly to an author of the interaction.

10. The system of claim 8, wherein the predetermined method of communication associated with each respective user is chosen from a group of communication types consisting of: direct messaging, email, text messaging, voicemail, and automated calling.

11. The system of claim 8, wherein the method performed by the processor further comprises:
analyzing, using a natural language processing model, the natural language content of the recording;
detecting, based on the analyzing, a request for the user to record the interaction;
identifying the user by searching a contact list that comprises the target audience of users; and
sending, automatically, the request to record the interaction to the user using the predetermined method of communication associated with the user.

12. The system of claim 11, wherein the request to record the interaction includes a time point of the recording where the request to record the interaction was made.

13. The system of claim 11, wherein the method performed by the processor further comprises:
training the natural language processing model to detect a plurality of interaction requests from a recording corpus of training data.

14. The system of claim 8, wherein the augmented recording is merged with the recording to create updated recording.

15. A computer program product comprising a computer-readable storage medium having program instructions embodied therewith, the program instructions executable by a processor to cause the processor to perform a method comprising:
in response to a playback by a user of a recording comprising at least one of an audio portion or a video portion, recording an interaction of the user including at least one of asking a question or answering a question, during the playback to create a recorded interaction;
combining the recorded interaction with a recent context of the recording of a predetermined duration as a memory aid to the user to create an augmented recording;
storing the augmented recording in a repository as a single playback subset to form an artifact; and
sending a link to the artifact to a target audience of users using a predetermined method of communication associated with each respective user.

16. The computer program product of claim 15, wherein the method performed by the processor further comprises:
in response to receiving input from at least one of the target audience of users having used the link to the artifact, determining whether to update the augmented recording in the repository;
in response to a determination to update the augmented recording in the repository, using the input received to create another single playback subset to form a second artifact;
sending a link to the second artifact to the target audience of users using the predetermined method of communication associated with each respective user; and
in response to a determination to not update the augmented recording in the repository, sending the input from the at least one of the target audience of users having used the link to the artifact directly to an author of the interaction.

17. The computer program product of claim 15, wherein the predetermined method of communication associated with each respective user is chosen from a group of communication types consisting of: direct messaging, email, text messaging, voicemail, and automated calling.

18. The computer program product of claim 15, wherein the method performed by the processor further comprises:
training a natural language processing model to detect a plurality of interaction requests from a recording corpus of training data;
analyzing, using the trained natural language processing model, the natural language content of the recording;
detecting, based on the analyzing, a request for the user to record the interaction;
identifying the user by searching a contact list that comprises the target audience of users; and
sending, automatically, the request to record the interaction to the user using the predetermined method of communication associated with the user.

19. The computer program product of claim 18, wherein the request to record the interaction includes a time point of the recording where the request to record the interaction was made.

20. The computer program product of claim 15, wherein the augmented recording is merged with the recording to create updated recording.
